(19) United States
(12) Patent Application Publication
(10) Pub. No.: US 2017/0142813 A1
(43) Pub. Date: May 18, 2017

(54) Intelligent controller

(71) Applicants: Ranbir S. Sahni, Long Beach, CA (US); Ian Cumming, Long Beach, CA (US)

(72) Inventors: Ranbir S. Sahni, Long Beach, CA (US); Ian Cumming, Long Beach, CA (US)

(21) Appl. No.: 15/330,928

(22) Filed: Nov. 14, 2016

Related U.S. Application Data
(60) Provisional application No. 62/254,132, filed on Nov. 11, 2015.

(51) Int. Cl. H05B 37/02; A01G 9/20; A01G 1/00; H05B 33/08

(52) U.S. Cl. CPC H05B 37/0272; H05B 33/0845; H05B 37/0281; H05B 37/0227; A01G 9/20; A01G 1/001

(57) ABSTRACT

A lighting controller has one or more output channels connected to the lighting, each channel comprising a lighting driver circuit, and having independently controllable intensity of the lighting from off to full power, a microcontroller containing instructions to control the intensity of the lighting by direct current or pulse width modulation, a communication connection adapted to communicate wirelessly with a control program, in communication with the microprocessor.

A method of operating a lighting controller is also described, having the steps of the app connecting to the lighting controller by a communication connection, wherein the lighting controller is connected to a plurality of channels connected to lights, a user adjusting an intensity control on the app, wherein the lighting controller adjusts the output of one of the channels accordingly, between off and full-power, a user inputting a light schedule.

### CROSS-REFERENCE TO RELATED APPLICATION

The present application claims priority to U.S. Provisional Patent Application No. 62/254,132 filed on 11 Nov. 2015, entitled “Intelligent Controller”, the entire disclosure of which is incorporated by reference herein.

### BACKGROUND OF THE INVENTION

1. Field of Invention

The present invention relates to a means and method to control light formulae for customization of lighting within a plant growing environment.

2. Description of Related Art

In agricultural and horticultural applications, light is not only a primary energy source for photosynthesis but also a vital regulator for numerous processes in plant photomorphology. Light intensity and quality are essential for plant growth, morphogenesis and other physiological responses. The correct combination of monochromatic light (UV, blue, green red, far red) and white light is effective (and necessary) for plant growth and development. However, depending on the genus and species of plants (e.g., vegetables, microgreens, flowering plants, medical herbs, etc.) different spectra, intensities, wavelengths, color temperature and photo period of light may be required. For optimum results, the light profile should be customized to the particular needs of the plant throughout the day and life cycle. However there is little technology to allow growers the means to do so. Plants not only prefer customized light profiles, which may vary throughout the day and through different stages in their growth cycle, but also react to periods of light and darkness. Some plants need full spectrum lighting which mimics natural daylight which they have been exposed to in nature. Others thrive on a much less elaborate wavelength mix.

Traditional technologies such as high-pressure sodium, metal halide, ceramic metal halide, fluorescent, induction and plasma lighting have fixed spectra. They can be dimmed, but in so doing, all wavelengths are dimmed proportionately. Solid state (LED) lighting allows for the control of each wavelength or color temperature, individually or in groups, allowing horticulturalists to select their own light profile based on experience. Many prior art devices have used the combination of red and blue (RB) light, or specific phosphors (including remote phosphors), to produce a range of wavelengths within the photosynthetically active radiation range (PAR, which covers from 400 nm to 700 nm), or color temperatures from 2000K to 10,000K in an attempt to mimic natural sunlight or optimize yields. In addition, there are wavelengths outside of PAR which affect plant photobiology. Examples are UV and Far Red light.

In addition, plants require different lighting profiles and exposure during different phases of the growth cycle. In the prior art, growers have lights with set profiles in certain areas, and move plants from one area to another either manually or via conveyor belts. For example, germination, vegetative growth, blooming and flowering may require different light profiles and exposure times for optimum yields Moving plants manually is time and labor intensive, and conveyors are expensive to install and maintain. It would be beneficial to change the light profile of any group of lights in any area at the touch of a button, saving labor and/or conveyor costs.

More particularly, for maximum efficiency to utilize light sources in any application where light is the energy source, such as horticulture, agriculture (plants and animals), aquaculture, etc., the user requires the ability to control the light spectrum, color temperature, light intensity, as well as the light pulsing frequency and duty cycle.

There are many other factors besides light that affect plant growth and yields. A few examples: soil quality, nutrients/fertilizer, temperature, humidity, carbon dioxide, pH, airflow, etc., all of which have to be optimized and monitored.

Some solutions, such as 0-10V dimming, for controlling light involve constant current systems wherein the intensity must be changed on all channels equally. Constant current is unable to vary individual channels unless each channel has a separate driver.

Based on the foregoing, there is a need in the art for a flexible LED grow light controller, which may vary spectra, duty cycle, schedule, intensity and other factors that permit optimal growing conditions, that will save labor and/or conveyor costs in moving plants around.

### SUMMARY OF THE INVENTION

It is an object of this invention to provide the means for the user to customize and control the light profile in order to optimize performance. Quantity may be sacrificed for better quality. For example, by enhancing phycoerythrin and phycocyanin, flavor, antioxidants and nutrients can be increased but this may cause a decline in yield.

Another object of this invention is to preselect five light spectra and enable users to modify and add to these based on their own experience. This enables the user to maximize harvest yields per genus and species taking into account plant growth cycles using the least amount of energy (electricity).

A further object of this invention is designed to allow each of 5 channels to be individually adjusted from 0% (off) through 100% (maximum intensity) Each channel may contain the same wavelength or a mixture of wavelengths from 200 nm to 850 nm and a correlated color temperature from 2000 degrees Kelvin to 10,000 degrees Kelvin.

Still another object of this invention is to allow the user to select either direct current manipulation or pulse width modulation (PWM) to set light intensities. This further allows for the use of strobing to intensify photosynthesis and photobiology.

There is currently no lighting controller that can establish a mesh network of a large number of luminaires (up to 2000 luminaires and 6000 individual light bars), while managing the operation of the luminaires through creating groups, associating light profiles within each group, switching light profiles with an easy user interface, setting on/off times and schedules for the lights according to group, allowing the adjustment of intensity and light profiles by varying direct current or pulse width modulation, and monitoring and adjusting the information from a plurality of sensors, such as, for example, pH, CO₂, humidity, temperature, and air velocity, among others. This information can then be transferred via the controller/app to the cloud via the Internet of Things (IoT).

This invention provides a way for a user to create their own light profiles or “recipes” for maximum effectiveness and yields.

This system uses a constant voltage power supply as opposed to most control systems which use constant current supplies and 0-10V dimming, giving full control in adjusting the intensities of individual channels within each luminaire in the system.

The system is designed to control multiple channels on each LED board, allowing adjustments of intensity by varying current directly or via PWM (pulse width modulation). Each of the channels can be individually manipulated changing intensities from 0% (off) through 100% and in-so-doing allowing the user to set colors and intensities throughout the spectrum. They can vary between full spectrum to monochromatic colors

The system comes with 5 preset light recipes (formula) with the ability to save alternative user defined recipes. This avoids having to move plants as they travel through their life cycle events such as seeding, cloning, vegetative growth, blossoming, flowering and fruiting. Instead of moving plants which is either done manually or with a conveyor belt, the light recipe can be changed at the touch of a button.

All changes can be can be programmed with a smart phone/tablet Android and iOS application or by a computer, and the system allows for the ability to create a BLE mesh network that consists of up to 2000 addressable devices.

The system allows for the creation of “rooms” and “groups”, and allows for the ability to assign luminaires to the abovementioned rooms and groups. It also allows for the ability to assign five standard light recipes or additional user defined recipes to rooms or groups.

The system allows for setting On and Off times for each recipe, room or group. The system checks and verifies times via the internet to accommodate power outages or accidental or deliberate power downs. The system remembers its last setting prior to shut down and will automatically revert to this position. Photoperiod, color, spectrum and intensity can be set giving full control to the user.

The system allows for feedback and auto shutoff if any LED board should overheat, and thermal management of the controller is attained by using a specially designed heat sink with or without fans.

The system is designed to manage feedback from up to 400 sensors and notify users by text message or email and automatically adjust to preset levels. These include spectrum (light recipe) CO2, temperature, humidity, pH, oxygen, airflow. etc.

There is an option to transfer all setting and data collected to the cloud. This can be retrieved at any time, but especially following catastrophic events.

The individual channels may consist of monochromatic wavelengths from 250 nm to 850 nm and color temperatures from 2,000 degrees Kelvin to 10,000 degrees Kelvin.

A lighting controller has one or more output channels connected to the lighting, each channel comprising a lighting driver circuit, and having independently controllable intensity of the lighting from off to full power, a microcontroller containing instructions to control the intensity of the lighting by direct current or pulse width modulation, a communication connection adapted to communicate wirelessly with a control program, in communication with the microprocessor, and a power connection connected to the output channels, the microcontroller and the communication connection, wherein the power connection is adapted to receive power from a power source.

The lighting controller may also have up to 400 sensors connected to the microcontroller selected from the group consisting of, for example, an ambient light sensor, a temperature sensor, a pH sensor, a humidity sensor, a CO2 sensor, an air flow sensor, etc.

The lighting controller may have a CHx buffer and a CHx driver adapted to translate instructions to and from the buffer. The communication connection may be adapted to communicate with a plurality of other communication connections within other lighting controllers, such that the controllers may daisy chain a signal to communicate over longer distances. The control program may be adapted to provide a lighting schedule. The controller may also have an independent timer, wherein the communication connection, control program and microcontroller receive a timing signal from the timer to ensure accurate on/off times.

A lighting controller system may have a controller comprising a power connection adapted to receive power, a microprocessor, a communication connection in communication with the microprocessor, a memory adapted to store data for the microprocessor, one or more sensors connected to the microprocessor, one or more output channels to power and control one or more grow lights, each channel comprising a grow light driver, with one or more grow lights connected to each of the one or more output channels, further a computing device connected to the communication connection, the computing device comprising a software having an intensity control for each output channel, and a schedule to control the off and on schedule of each output channel.

The lighting controller may have a cloud server wirelessly connected to the communication connection as a backup for storing all information for each site where the controllers are deployed, and for containing a database of light recipes for particular genus and species of plants.

The microprocessor may contain instructions to control intensity of output channels by pulse width modulation. It may have feedback and rules from up to 400 sensors such as an ambient light sensor, a temperature sensor, a pH sensor, a humidity sensor, a CO2 sensor and an air flow sensor. There may be an independent time synching mechanism adapted to provide a synched time to the microprocessor, the software and the communication connection.

A method of operating a lighting controller is also described, having the steps of the app connecting to the lighting controller by a communication connection, either Wifi or Bluetooth (BLE), wherein the lighting controller is connected to a plurality of luminaires, whereby a user may adjust the intensity of light emitted by several independent light channels, between off and full-power. A user may also input a light schedule, wherein the on and off times of each of the channels and the lighting controller receives signals from one or more sensors and communicates the signals to the app. A user may use preprogrammed light profiles or may define his/her own.

The method may have the additional step of describing the grow environment by creating separate groups configured to group plants, wherein a room and a group comprises a plurality of luminaires managed by one or more lighting controllers, and assigning one or more light profiles to each group.

The intensity control may vary power of each channel by pulse width modulation. The intensity control varies power of the channel by varying channel current. The groups may comprise luminaires segmented by rooms or other criteria, and an independent timer may be used to synchronize on off times without the use of a real time clock.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows:

FIG. 1 is a schematic view of the controller and environment, according to an embodiment of the present invention;

FIG. 2 is a functional diagram of the controller, according to an embodiment of the present invention;

FIG. 3 shows the time-synching mechanism for the light controller, according to an embodiment of the present invention;

FIG. 4 is a plan view of the controller PCB, according to an embodiment of the present invention;

FIG. 5 is a perspective view of the light units with the controller mounted thereto, according to an embodiment of the present invention;

FIG. 6 is a functional diagram of the controlling application, showing how to set up groups and then association light profiles for each group according to an embodiment of the present invention;

FIG. 7 is a further functional diagram showing interaction with the sensor environment, according to an embodiment of the present invention;

FIG. 8 is a further functional diagram of the controlling application software component of the computing devices, according to an embodiment of the present invention;

FIGS. 9-13 are screenshots of the controlling application, according to an embodiment of the present invention;

FIG. 14 shows a circuit diagram of the controller, according to an embodiment of the present invention;

FIG. 15 shows the circuit diagram of how the controller is physically connected to each of the 5 channels on the LED boards, according to an embodiment of the present invention; and

FIG. 16 shows a heat sink for a LED light, according to an embodiment of the present invention.

### DETAILED DESCRIPTION OF PREFERRED EMBODIMENTS

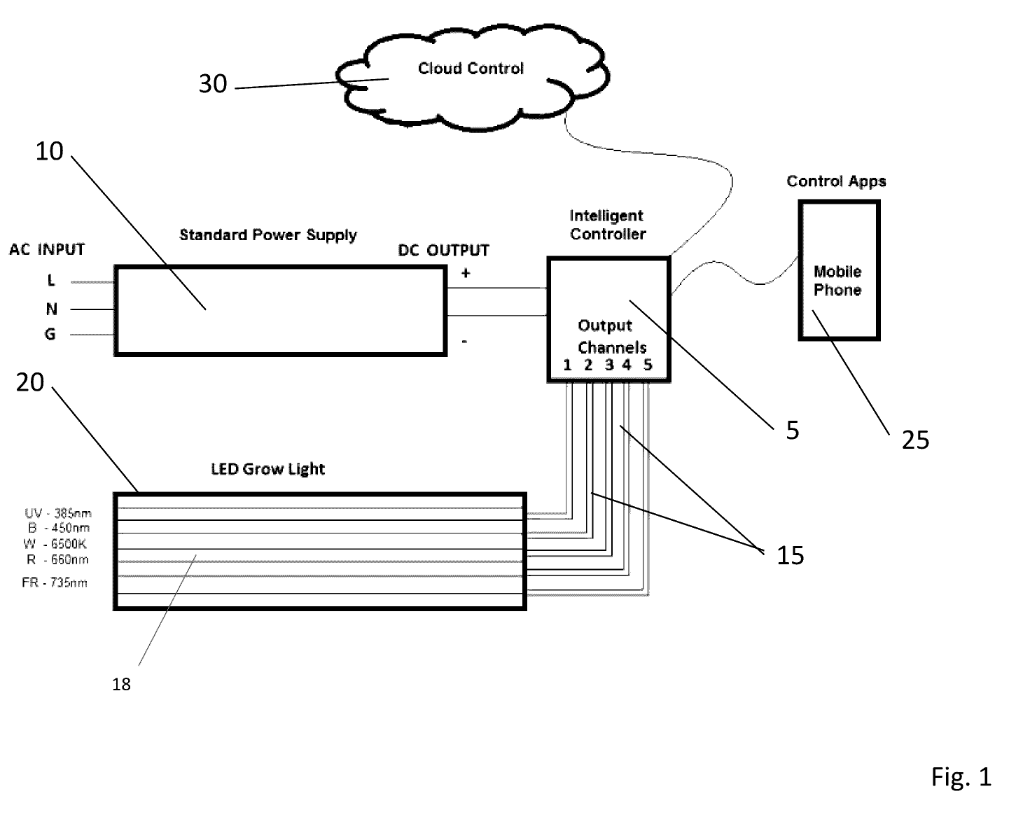

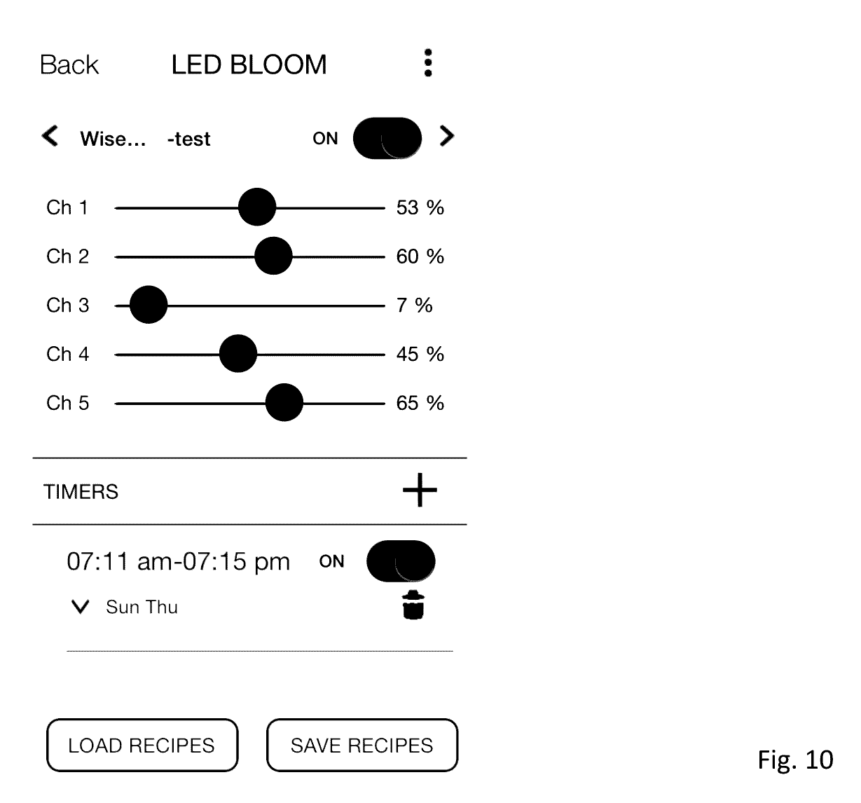

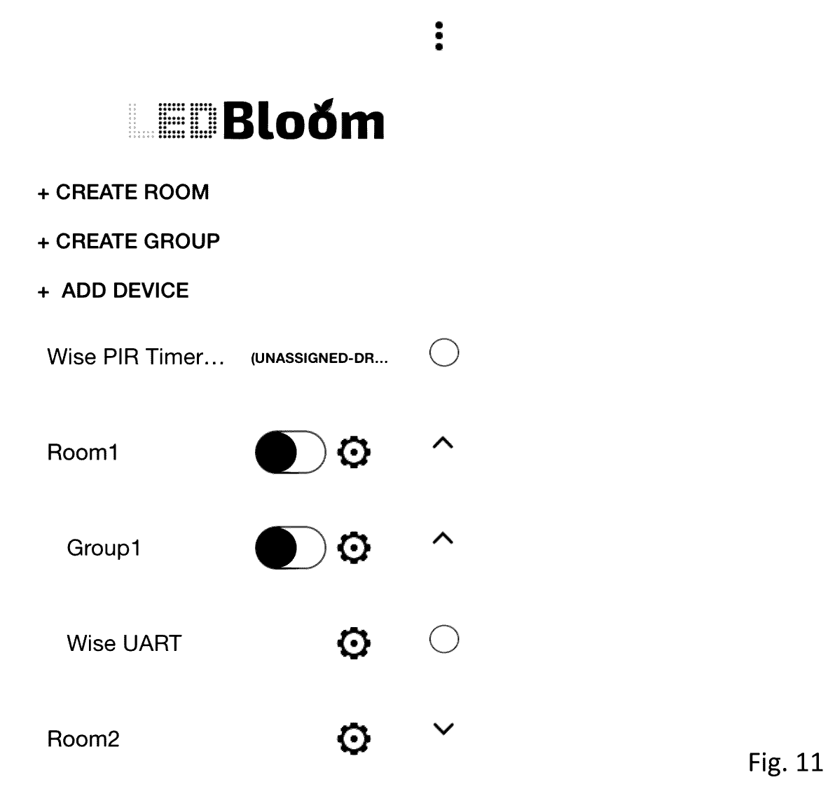

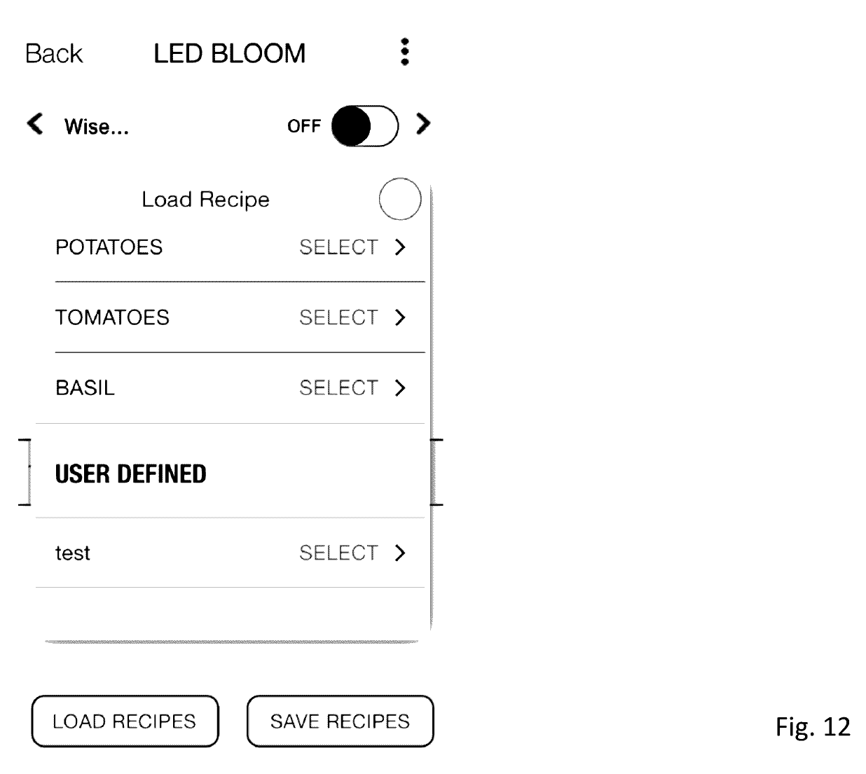

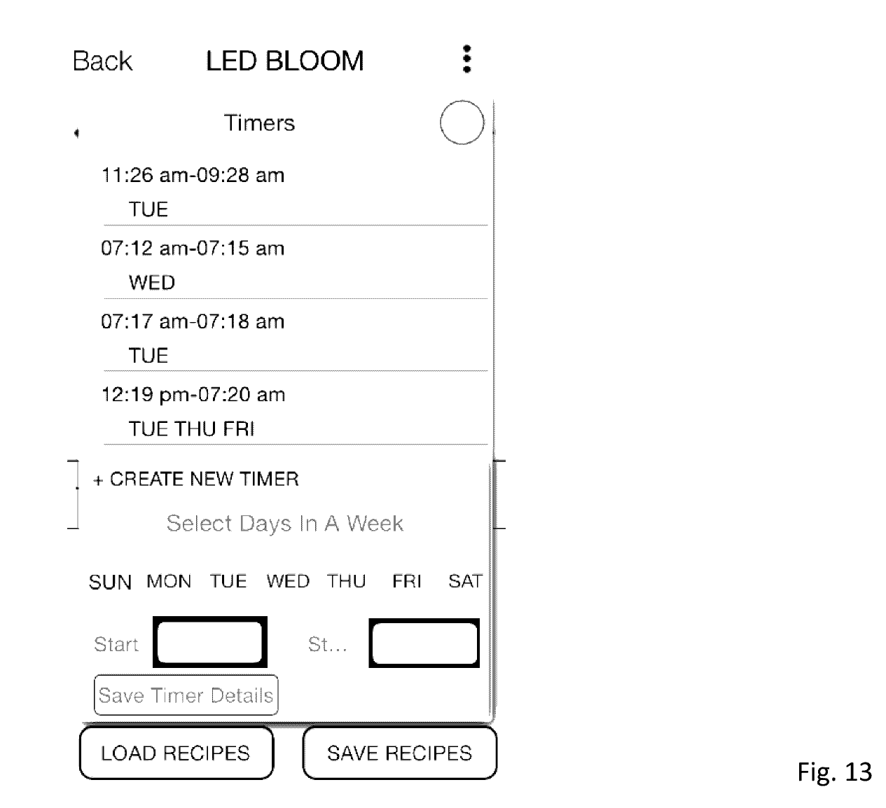

Preferred embodiments of the present invention and their advantages may be understood by referring to FIGS. 1-16, wherein like reference numerals refer to like elements.

The controller permits a user to control the light profile, intensity and timing in order to maximize yields based on set objectives. The invention creates a mesh network of up to 2000 luminaires, sets up groups within this network, allows a customized light profile to be generated for each group, sets on/off times, receives feedback from up to 400 sensors, activates plant circadian rhythms, keeps all records in the cloud.

The first controllable aspect of the system is the light spectrum. The invention uses a combination of monochromatic LEDs from 200 nm to 850 nm and/or “white” LEDs with a correlated color temperature (CCT) between 2000 degrees Kelvin and 10,000 degrees Kelvin. As stated above, some prior art devices use a combination of red and blue (RB) light, or specific color temperatures from 1000K to 30,000K CCT. In general, these do not include the UV spectrum (from 200 nm-380 nm) or Far Red at around 740 nm.

The horticulturalist's selected light spectra are carefully chosen to produce maximum performance, effectiveness, and highest efficiency based on user criteria and experience. In other words, the user can get the maximum harvest and maximum yields using past experience while at the same time reducing energy (electricity) consumption.

The second controllable aspect, light intensity, generally related to how much photosynthetic photon flux density (PPFD) the LED luminaire emits. No prior art devices can achieve this full range of control and customization for optimum results. In the present invention, the light intensity may be precisely adjusted by controlling the current that is provided either through the driver directly or manipulated by pulse width modulation (PWM), the rapid alternating of the LED between on and off states over a number of intervals per second. Controlling the current by either methodology results in a lower or higher intensity for a given LED string. The intensity may be customized to provide a different intensity at different times of the day and different phases in the growth cycle.

Pulse width modulation controls the on/off period of the LED over a number of intervals per second. The number of intervals represents the frequency of pulses, and the amount of time the LED is illuminated during each interval is the duty cycle. In other words, the frequency is the number of intervals per second, and the duty cycle is the amount of time during each interval that the LED is on. A shorter duty cycle means the pulse is shorter within each interval, providing lower power output per interval. Conversely, a longer duty cycle provides more output per interval. A light source manipulated with pulse width modulation may ultimately be perceived by the plant and humans as having a lower intensity than a constant light source.

The third controllable aspect of light is the scheduling of when the light is on during a given day and when it is off While the light is on, it may also be desirable to change the color spectrum throughout the day to mimic natural daylight (sunlight). Terminating with far red near the end of the day communicates to the plant that it is time to adjust its circadian system and switch from “light” photosynthesis to “dark” plant processes. Just as the sun rises with a skyline that appears bluish, to the full white spectrum by mid-day, and warm red by sunset, a grow light can mimic this behavior. Plant growth may be optimized by mimicking this pattern of lighting over a day. It is well-documented that most plants are either short-day plants or long-day plants. Short-day means that the plant will start flowering when it senses that the day is getting shorter, with an example being most plants flowering in the fall, whereas long-day means that a plant will start flowering when the days get longer. Examples of these are most spring flowering plants. Thus, another object of this invention is to allow the user to have full control of this light duration and hence have full control of the when plant will or will not flower. Furthermore, with the use of UV light and far red light spectrum in this invention, the user can have full control of the plant's circadian rhythms (“wake” and “sleep” time).

A further controllable aspect is the different spectra of light for different periods within the lifecycle of the plant e.g. from seeding, germination, to vegetative growth, budding/blooming, flowering, and harvesting. For most plants, the seeding and germination stage requires more bluish light, whereas plants will prefer much warmer, more reddish light when flowering and harvesting. Thus, it is another object of this invention to allow the user full control of these adjustments to achieve different light spectra for different periods of the growth cycle for optimum results. Note that the latest horticultural science prefers life cycle “tuning” rather than daily “tuning” mentioned above.

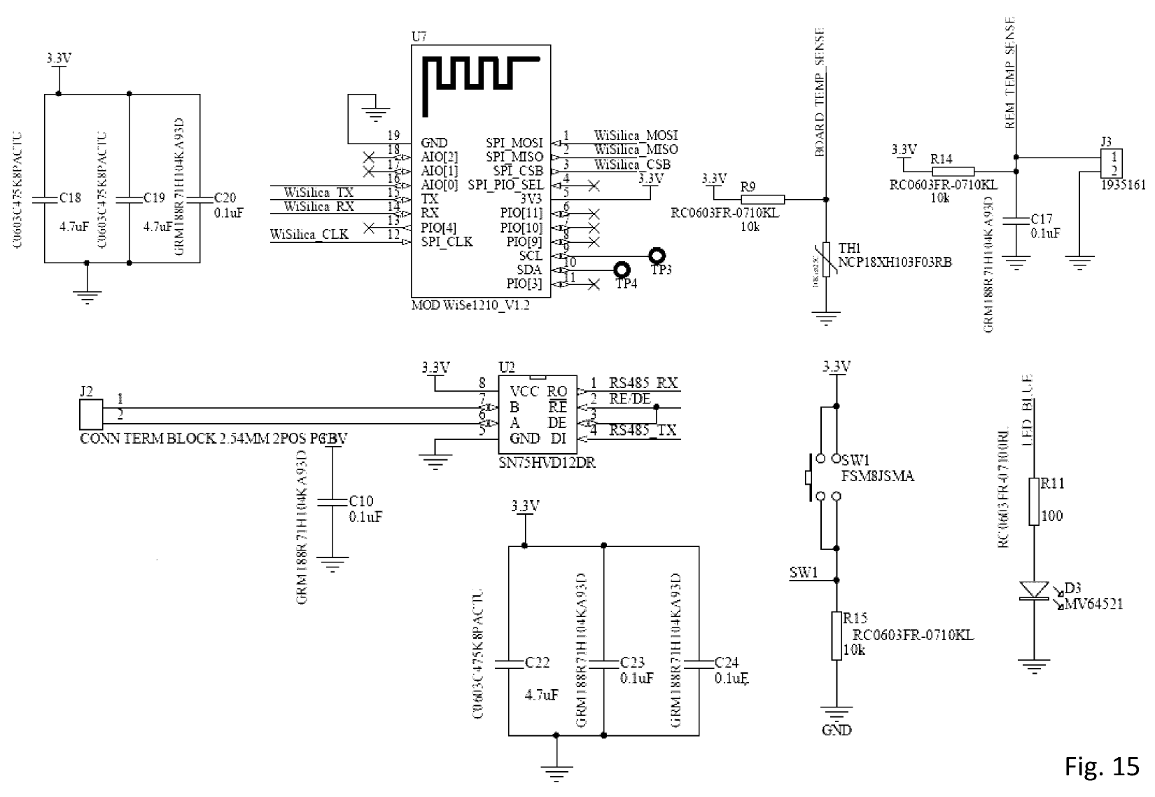

FIG. 1 shows a schematic diagram of the invention with example wavelengths. The controller 5 is designed to provide full control and customization for all aspects of light mentioned above. It is connected to a constant voltage DC power supply 10 which may receive AC input. The controller 5 has a plurality of output channels 15 (five in this example) connected to a plurality of LED grow lights 20 (One shown in this example). LED chips are positioned on printed circuit board tracks 18 to form light strings or channels (in this example five channels to match the five output channels of the controller 15). A control device 25, for example, a smartphone/tablet running the control app, is connected wirelessly to the controller 5 either by Bluetooth (BLE) or Wi-Fi. The controller 5 is also connected to a back-end in the cloud 30 through a router or other communication wireless device (not shown). The controller is a separate device designed not as a part of the LED driver as in the prior art In doing so, the controller can drive a wider range of LED luminaires using standard, off-the-shelf, constant voltage power supplies without the need for a redesigned LED driver to match the LED engine (i.e., LED bars). This will reduce development cost and provide a quick path to market. In an embodiment, each channel 15 has an LED driver circuit (see, for example, FIG. 15) therein to provide power to a plurality of LED chips in a given channel. The LED chips may be selected separately to have suitable wavelengths and/or color temperatures, as explained above. There is a proviso that the sum of the forward voltages of the individual chips should not exceed the total voltage of the constant voltage power supply. The wavelengths listed on the figure are merely exemplary and are not limiting to wavelengths in use by the system.

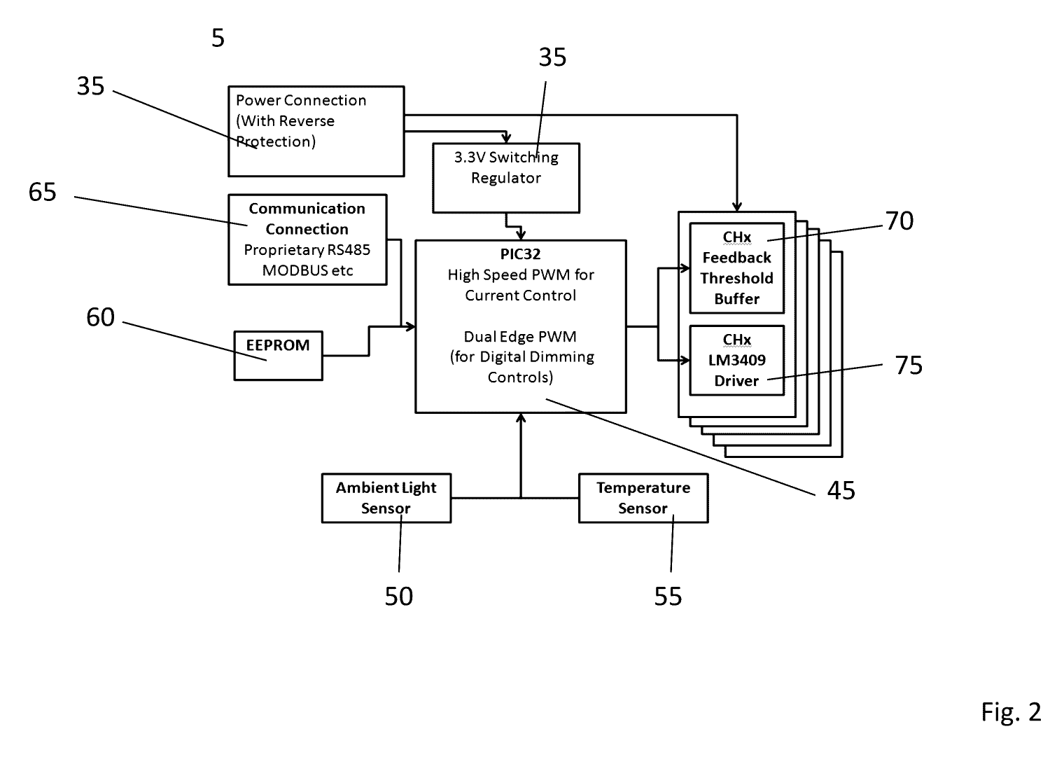

FIG. 2 shows a functional diagram of the controller 5, wherein the controller has a power connection 35, optionally with over-current protection, that is connected to the DC power supply. The power connection 35 provides power through a regulator to the microcontroller 45 that controls intensity via pulse width modulation or directly through current, as well as other signals. The microcontroller 45 also contains firmware for dual edge PWM (described in further detail below), in an embodiment. It may receive sensory input from, for example, an ambient light sensor 50 or a temperature sensor 55, amongst others. Other sensors connected to the controller 5 may include humidity sensors, pH sensors, air flow sensors, CO2 sensors and many others. Further, a spectrometer or other color measuring device may be positioned to read the spectral power diagram (SPD) of the luminaire 50 and which then provides feedback of the spectrum to the controller, which then can automatically adjust the SPD to that set up in the original programming. As LEDs age, the SPD may also change so the spectrometer input maintains and ensures consistency. The microcontroller contains and/or is connected to memory 60, and a proprietary communication connection 65 that may be wireless or wired. It is also in communication with a CHx feedback threshold buffer 70 and a CHx driver 75 to translate instructions to the buffer 70 and save information in case of power failure and for communication to the cloud.

The communication connection 65 may use a standard protocol such as Bluetooth/Bluetooth Low Energy (BLE) or Wi-Fi. With Bluetooth, the controllers will “daisy-chain” to form a mesh network and cover longer distances throughout a grow facility, and extend the effective range of the Bluetooth communications enabling commands to be sent and received throughout the network. Accordingly, the controllers 5 are each in communication with one another. The communication connection 65 also contains logic for interpreting the commands from the controlling app 66 (on a smartphone, tablet or other computer) and disseminates the commands to the controllers, such that each grouped controller 5 may be controlled from one instance of the app.

A device such as a smartphone/tablet either communicates with the controller 5 using BLE via the IOS/Android App or via a Cloud based dashboard using Wi-Fi. All luminaires, once configured via the app, may be set up as a mesh network and communicate with each other and to the cloud via Bluetooth (BLE) and/or Wi-Fi. One of the benefits of cloud storage is that with user permission, a database of optimal light recipes for different plant genus and species can be collected and stored in a library which is accessible and may be retrieved through the app.

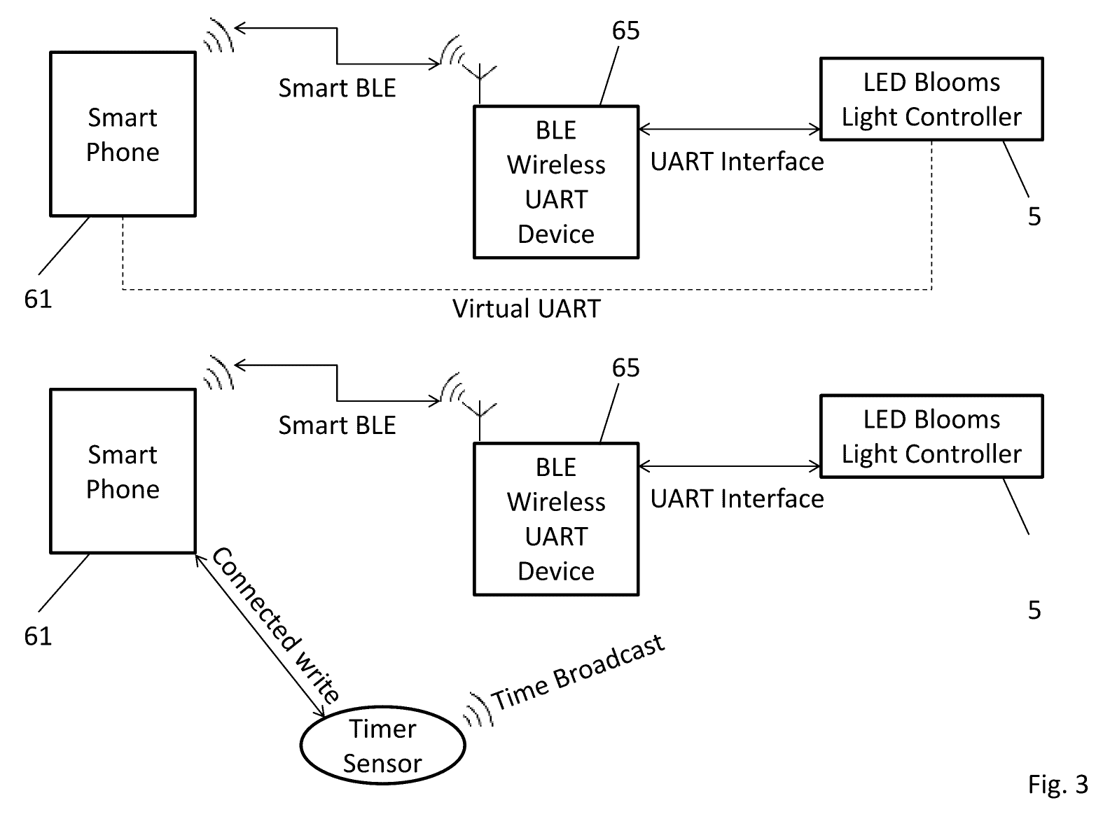

With reference to FIG. 3, a time synching mechanism 63 may be present to permit the controller 5, the app on the smartphone 61 and the communication connection 65 to synch clocks, even after power outages or system resets. Alternatively, the app may derive a system time and disseminate the time through the communication connection 65 (UART device) of the controller 5, such that a standardized time may be determined and maintained in synch.

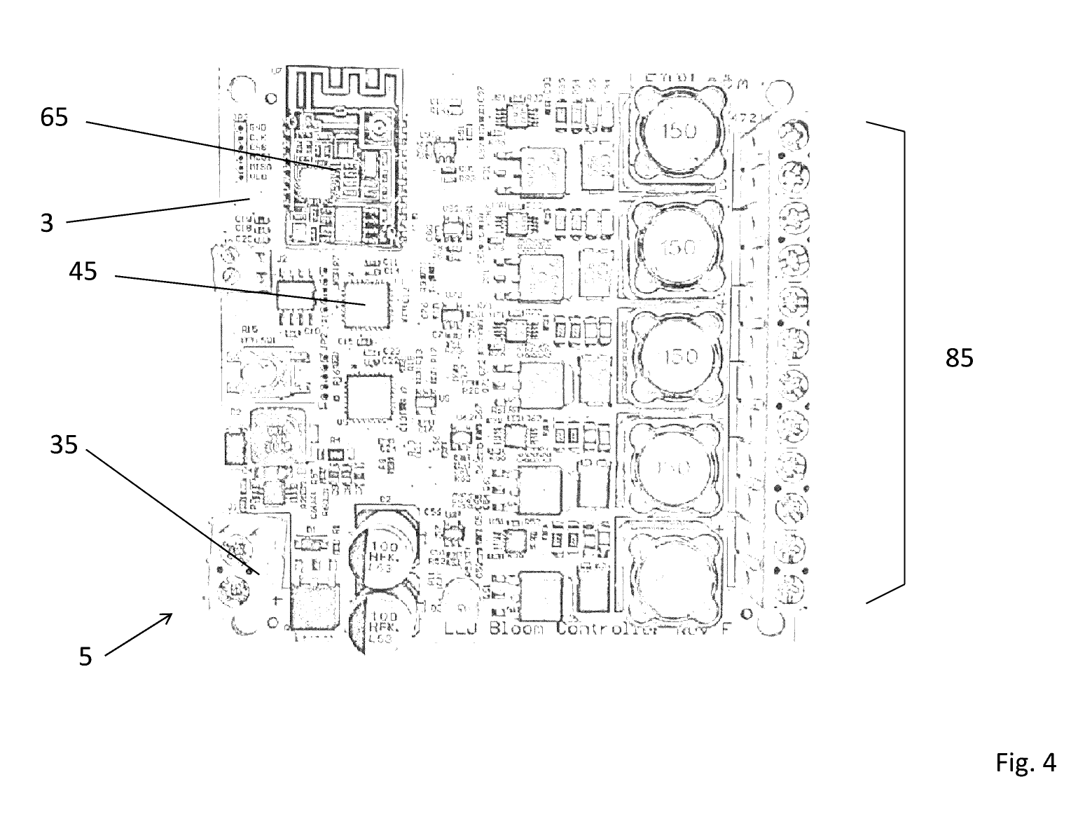

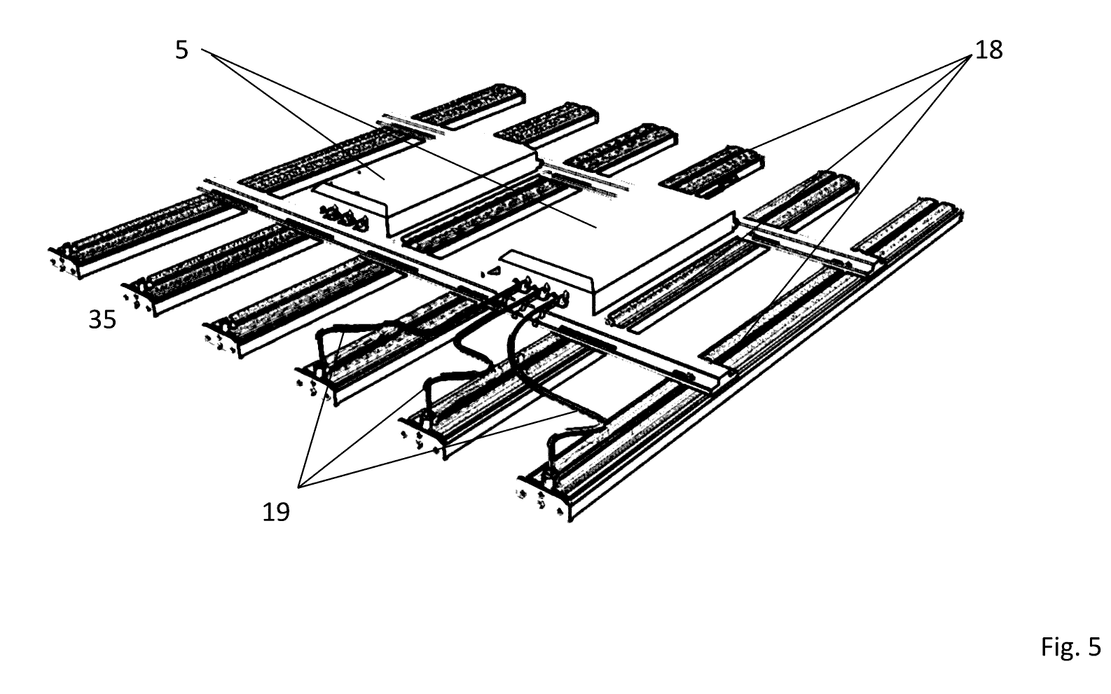

With reference to FIG. 4, an example implementation of the controller 5 is shown in a printed circuit board (PCB) format. Mounted on the PCB 3 are the controller 5 and a microcontroller 45 that contains hardware or firmware for managing the intensity through direct current manipulation or PWM. The power connection 35 enables power for the PCB and components.

With further reference to FIG. 4, and as stated above, intensity can be varied either directly or via PWM. The microprocessor 45 features Dual Edge PWM Dimming and the ability to control the ON and OFF position of each of the channels. This allows for fast sequencing of the LEDs. An advantage of this is that each LED driver can be programmed to deliver higher current for short durations to each of the channels without taxing the primary power supply.

In one embodiment, the system uses a 48VDC constant voltage power supply as opposed to most control systems which use constant current supplies and 0-10V dimming. Therefore, each LED channel 85 may contain a number of LEDs wherein the total voltage of the LEDs on that channel adds up to 48V. The forward voltage of LEDs is not standardized and varies depending on the wavelength. For example red LEDs require 2.2V, whereas blue and white require 3.3V. Therefore, at 48VDC, a string of red LEDs may comprise approximately 22 LEDs, whereas a string of blue or white LEDs may comprise approximately 15 LEDs.

With reference to FIG. 5, a light fixture is shown with two controllers 5, each controller 5 connected to three LED light bars 18 each of which is comprised of 5 channels and each channel contains a plurality of LEDs. Three LED bars 18 are connected to and are controlled by a single controller 5 by 12 core cables 19.

In an embodiment, a single controller 5 powered by a single 48VDC constant voltage power supply is designed to manipulate 3 LED bars each of which has 5 separate controllable channels. Each of the plurality of channels can be individually manipulated changing intensities from 0% (off) through 100% (full power) by direct current adjustment, or by pulse width modulation.

By way of example, the following wavelengths of LEDs may be used: 265 nm, 295 nm, 365 nm, 395 nm, 410 nm, 430 nm 450 nm, 525 nm, 580 nm, 620 nm, 660 nm, 730 nm, warm white (2500-3200K) natural white (4000- 4300K) and cool white (5000-6500K). These may be changed from time to time, and may be standardized and stored within the system. These wavelengths are non-limiting and may be selected to accommodate a particular genus and species of plant and lifecycle event.

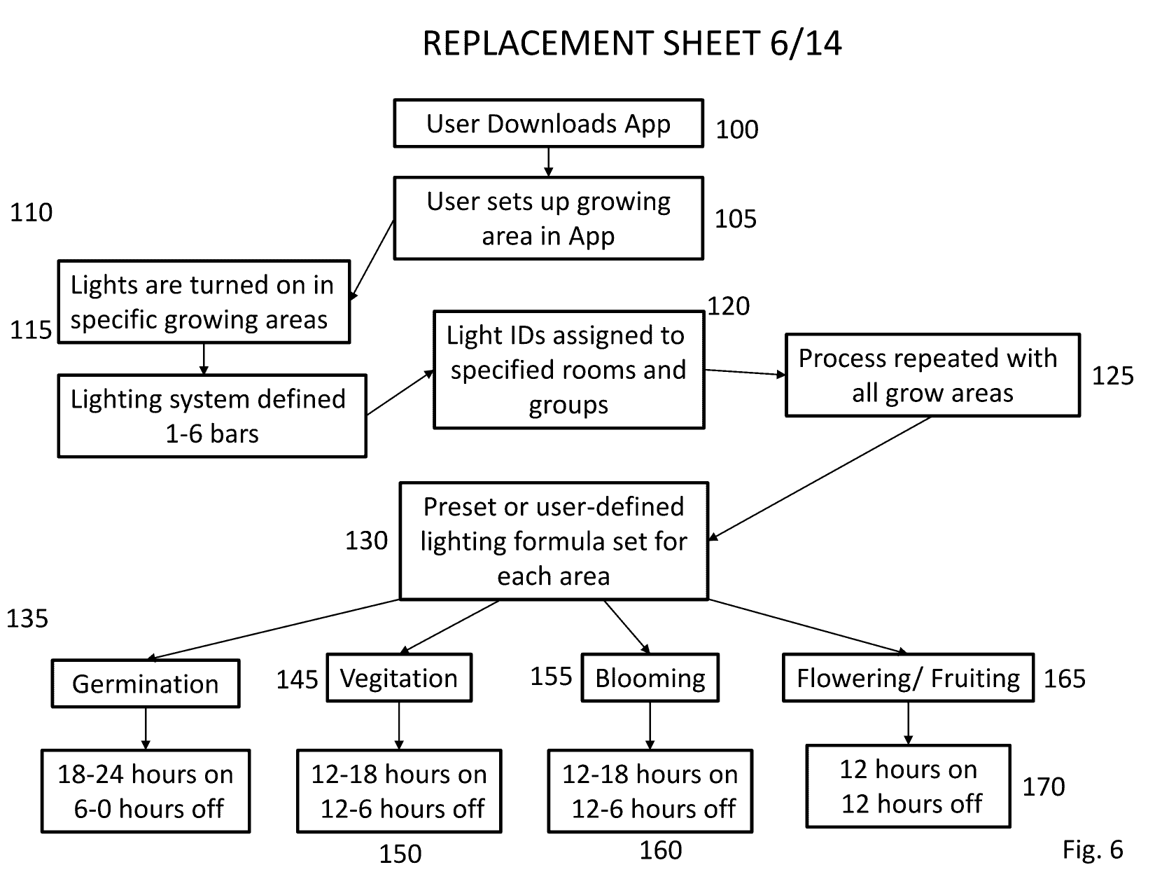

In operation, as depicted and also described in the steps outlined in FIGS. 6-8, the user will turn on the lights, and once the lights are turned on, at step 100 the user will download the app to their device and begin by describing their growing environment. This description, will include dimensions of grow area, answering questions such as “is the user growing in a vertical setting or single layer?” The user will then describe the distance between the light source and plants and the dimensions of each layer. The user will create different rooms/groups, i.e., germination room or layer, vegetation room or layer, bloom or flower and fruiting room or layer. Once this is accomplished, the user will be able to assign the ID's of the lights to those rooms/groups or layers and then program the operation of each light and set the light formulas. The user can either prescribe a preset light formula for the plant type or create a custom formula.

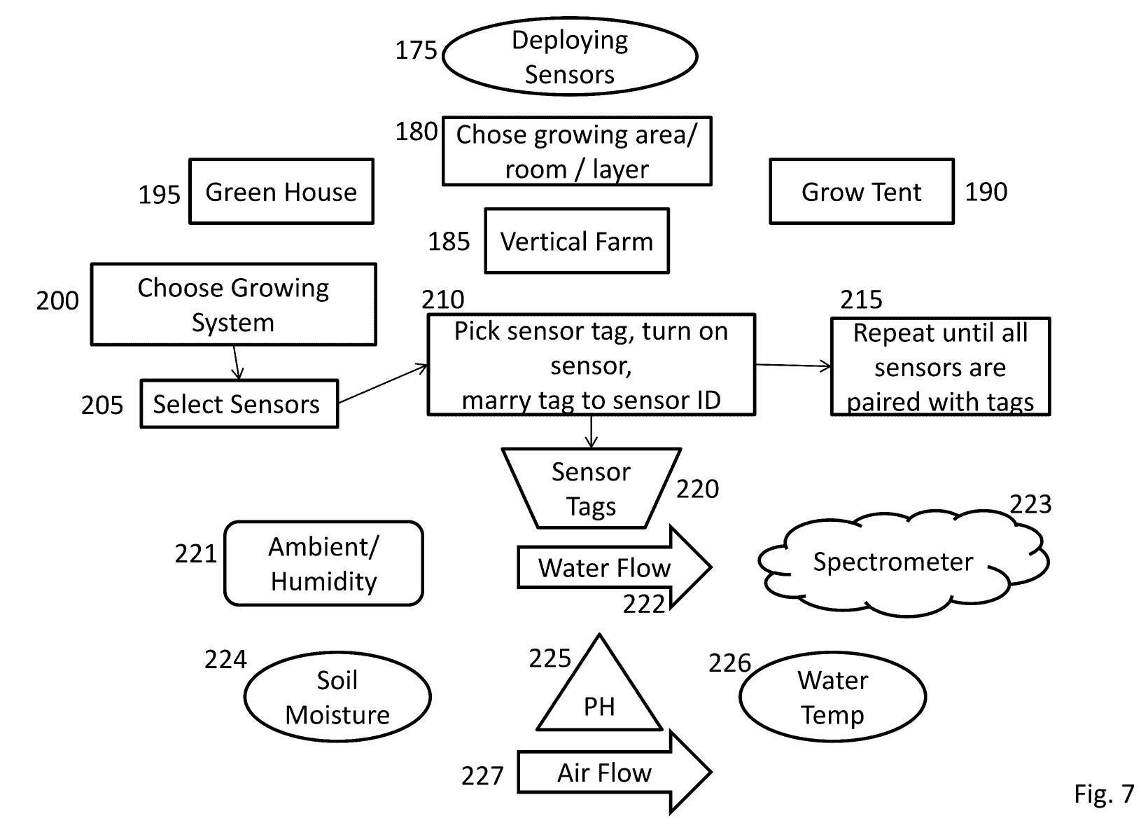

FIG. 7 relates to Deploying Sensors. Once sensors are deployed and ID's and appropriate tags set up, rules need to be established for each sensor. For example, if the pH sensor is reading high, then the user will set a rule to notify him or her by SMS or email so the user can either adjust the pH manually or, if the user's nutrient pump or doser is linked to the controller, the user will have it automatically adjust the pH. The sensors are connected to the communication connection 65 and have unique identification numbers and tags, so the controller can track and record input and take appropriate action.

With reference to FIG. 6, in step 100, the user downloads the app. In step 105 the user sets up a growing area in the app by defining rooms/groups, and provides the length, width, height, layers and dimensions of layers. In step 110, the luminaires are turned on in specific growing areas. In step 115 the lighting system is defined. In step 120, light IDs are assigned to specific rooms and groups, and in step 125 the process is continued throughout the grow facility. In step 130, once all the IDs are assigned to rooms and groups the preset or user defined lighting formula for each area is set. In step 135 to 170, on/off times are set for each group.

With reference to FIG. 7, in step 175 the sensors are deployed. The sensors may include devices to measure spectra, temperature, humidity, pH, dissolved oxygen, CO2, air flow, etc., as described above. In addition, a user may wish to play music, operate security cameras, check leaf transpiration, check fluorescence etc. by means of additional sensors, which may all be connected to the controller. In step 180-195 grow areas and groups are defined, at step 200 the growing system is selected, and once selected, at step 205 a selection of sensors is provided relating to that system. In step 210 the user will select a sensor tag and turn the sensor on. A sensor ID will pop up and the system will marry the tag to the sensor ID. In step 215 they will repeat this process until all sensors are married to the appropriate tag. In step 220 sensor tags monitor the input from a humidity sensor 221, a water flow sensor 222, a spectrometer 223, a soil moisture sensor 224, a pH sensor 225, a water temperature sensor 226 and an air flow sensor 227.

The spectrometer or photo sensor, once connected with the appropriate tag, will also require rule setting. For example, if the user is maintaining 220 Photosynthetic Photon Flux Density (PPFD) and clouds come over the green house and it drops to 200 PPFD, the lights will automatically come on and brighten until there will be a consistent 220 PPFD over the growing area. The user will also be able to create the same rule for indoor growing. However, lumen maintenance will be monitored, which means, as the LEDs degrade over time, the lighting systems will automatically increase current to the LEDs to maintain light levels until the system has maxed out its power capacity. This helps because growers maintain consistent yields month in and month out over the life of light fixture without suffering from the natural degradation of the LED. When feedback from a spectrometer or other wavelength measuring device is received by the controller, it can take action to adjust the spectral power diagram emitted by the luminaire to closely resemble the original specified SPD. Temperature/humidity sensors may be used to trigger fans, air conditioners and humidifiers/dehumidifiers.

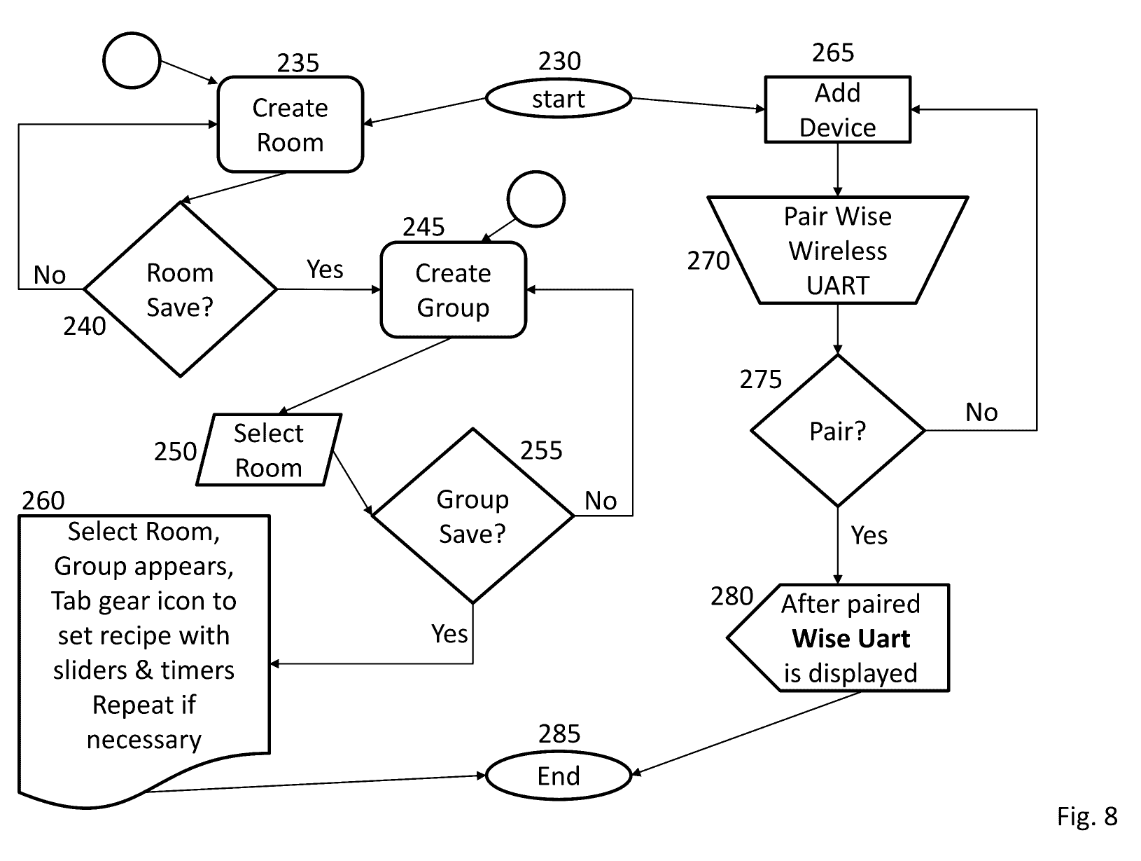

With reference to FIG. 8, the link to devices is described. Machines such as fans, HVACs, pumps, nutrient dosers, dehumidifiers, can be allocated an ID and tag to handshake with the controller through the communication connection 65. After setting up and tagging all machines, the user sets the rules of operation in a similar manner to the sensors. If rules of operation have already been set up for the sensors, then they will automatically be populated into the machine rules. However, pumps, irrigation, HVAC and the rest of the machines may have their own operating rules. Irrigation can be set to a duty cycle or can be activated by the moisture sensor. Hydroponic pumps could be set to flood the nutrient film technique (NFT) channels periodically.

With reference to FIG. 8, once the app is started at step 230, the user may create a room at 235. In step 240 the user has the option to save the room. If not saved the user has the option to modify the room in step 235. If the room is saved, then at step 245 the user creates a group, and in step 245 the room may be selected and in step 250 the user is given the option to save the group, which saves the configuration to the server. If the user opts not to save the group, they may return to modifying or editing the group at step 240. In step 255 the user may select a room and group, and may tab to a gear icon to set a lighting recipe with sliders and timers. The lighting recipe may be saved, and 235 and 245 may be repeated as necessary.

In step 265, one or more devices may be added using a unique device ID. In step 270 the devices are paired with the wireless UART. In step 275, the system verifies if the devices are paired. If not, the procedure returns to adding a device at step 265. If so, then at step 280 the UART is displayed. In 285 the procedure ends.

The mesh network covers the entire grow area. All sensors and machines communicate or send signals through the nearest controller via its RF communication module. This information will be received or transmitted using Bluetooth 4.0 or greater (BLE) or Wi-Fi. This controller is designed to work with multiple constant voltage power supplies, from 24VDC to 60VDC and a maximum of 4 amps per channel. OEM customers may design their LED PCB boards to match the controller outputs bearing in mind the specific constant voltage of the selected power supply. This controller may also be used for any DC power system that requires less than 240 watts such as a DC motor control for pumps, window blinds, greenhouse shades, nutrient dosers etc. The controller can be used with commercial lighting systems, 240 or lower watt fixtures. For example, one can operate 7-32 watt LED fixtures per channel.

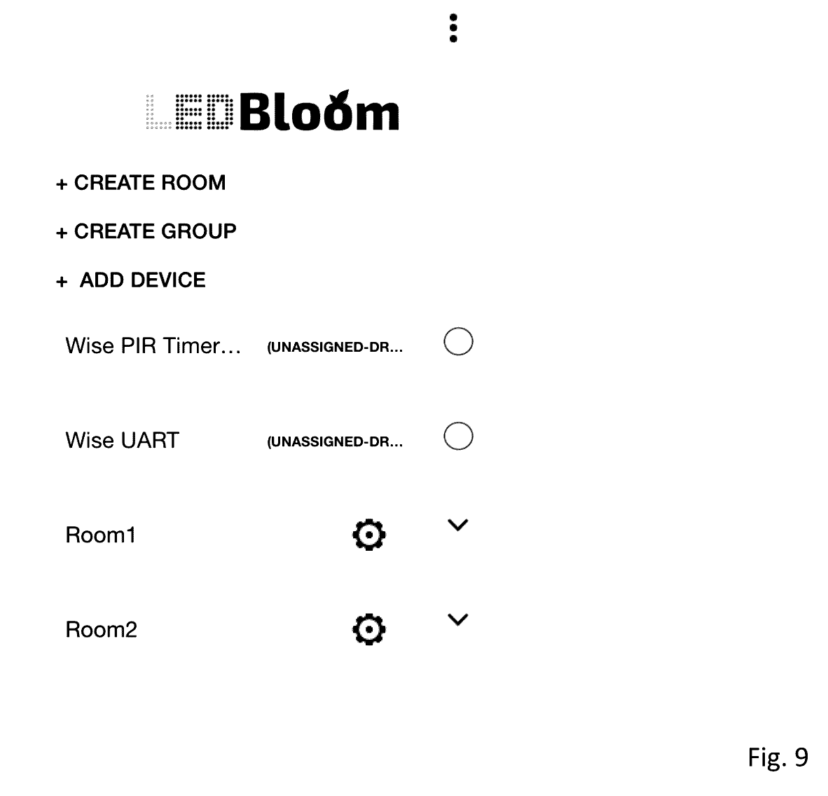

FIGS. 9-13, show screenshots of how the app is set up. Firstly, the user sets up rooms and groups. Then luminaires are allocated to each group, Next, light profiles (recipes) are set up for each group by using intensity “sliders” which vary between 0% (off) and 100% (maximum). Then on/off times are set. Another unique feature of this system is an independent timer which accesses real time via the internet and communicates this via BLE to each controller in the mesh network. The system checks and verifies times via the Internet to accommodate power outages or accidental or deliberate power downs. The system remembers its last setting prior to shut down, stored in the memory 60, and will automatically revert to this position. Photoperiod, color, spectrum and intensity can be set giving full control to the user.

The timer module includes a PIR motion sensor which can be used to send email/SMS messages and/or activate security cameras. A number of set recipes are provided with standard settings for particular varieties of plants and growth cycle events. At this stage, users may set up their own preferred light recipes.

By changing recipes, growers can avoid having to move plants as they travel through their life cycle events such as seeding/cloning, vegetative growth, blossoming, flowering and fruiting. Instead of moving plants, which is either typically done manually or with a conveyor belt, the light recipe can be changed at the push of a button.

The system is designed to manage feedback of up to 400 sensors and automatically adjust to preset levels. These include spectrum (light recipe), CO2 (carbon dioxide), temperature, humidity, pH, dissolved oxygen, air movement, etc. There is an option to transfer all settings and data collected to the cloud, to be stored on one or more servers. This can be retrieved at any time, but may have particular importance following catastrophic events.

In an embodiment, the LED drivers on the board may be upgraded to accommodate higher current and wattages. If this is done, power supply parameters may need upgrading to match. By taking this modular approach, the intelligent controller would only need to be designed once. The app provides for wireless control and/or cloud-based control of the intelligent controller. In the prior art, even with dimming functions or multi-channel functions, the control mechanism is usually built-in to the controller/driver. In this invention, the controlling interface may be downloaded to a smartphone/tablet or it can be run and controlled from the cloud.

All control functions can be changed/customized remotely via the cloud without the user being in vicinity of the grow area. Remote monitoring is also included.

Whereas specifically designed luminaires are preferred, the goal is to OEM this controller to other agricultural lighting manufacturers as well. In such cases, OEM buyers will have to design their fixtures to function with the controller.

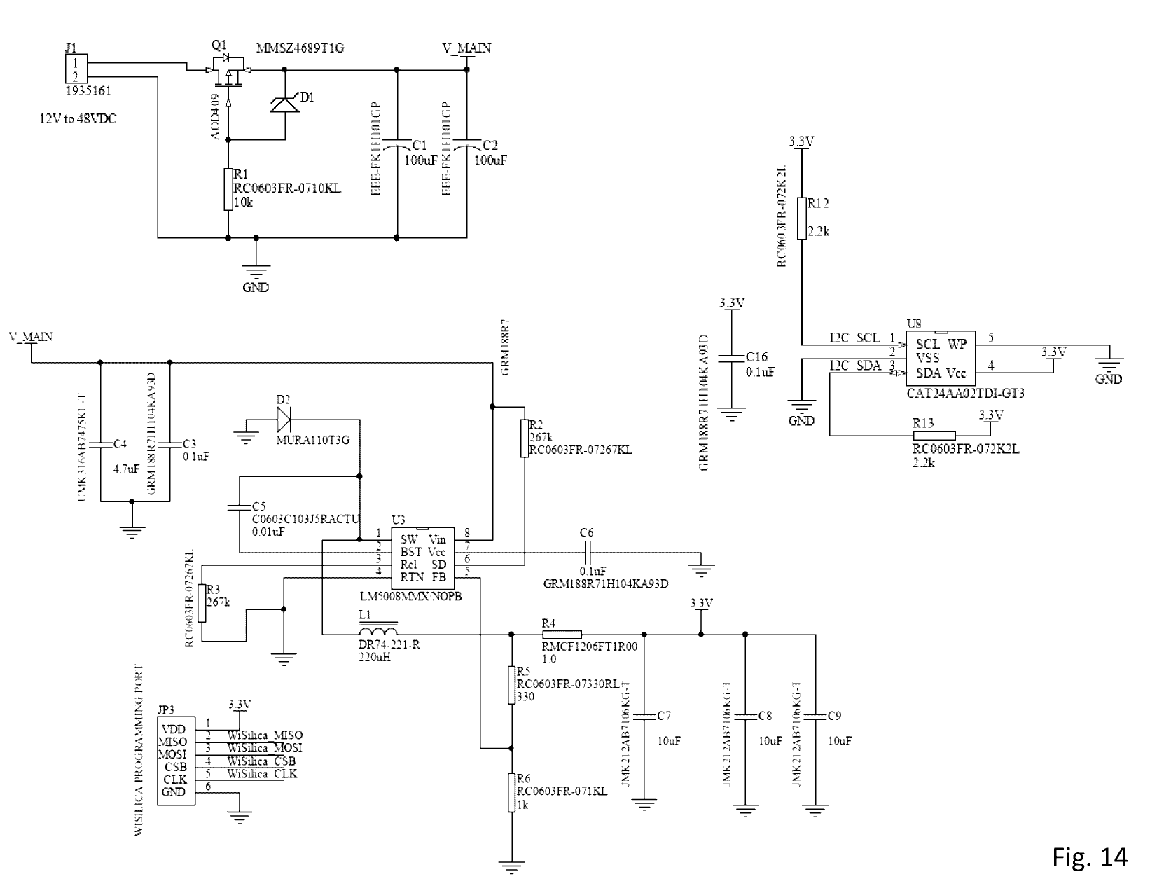

With reference to FIGS. 14 and 15, example circuit diagrams are shown for the controller and for the on board drivers for the 5 channels.

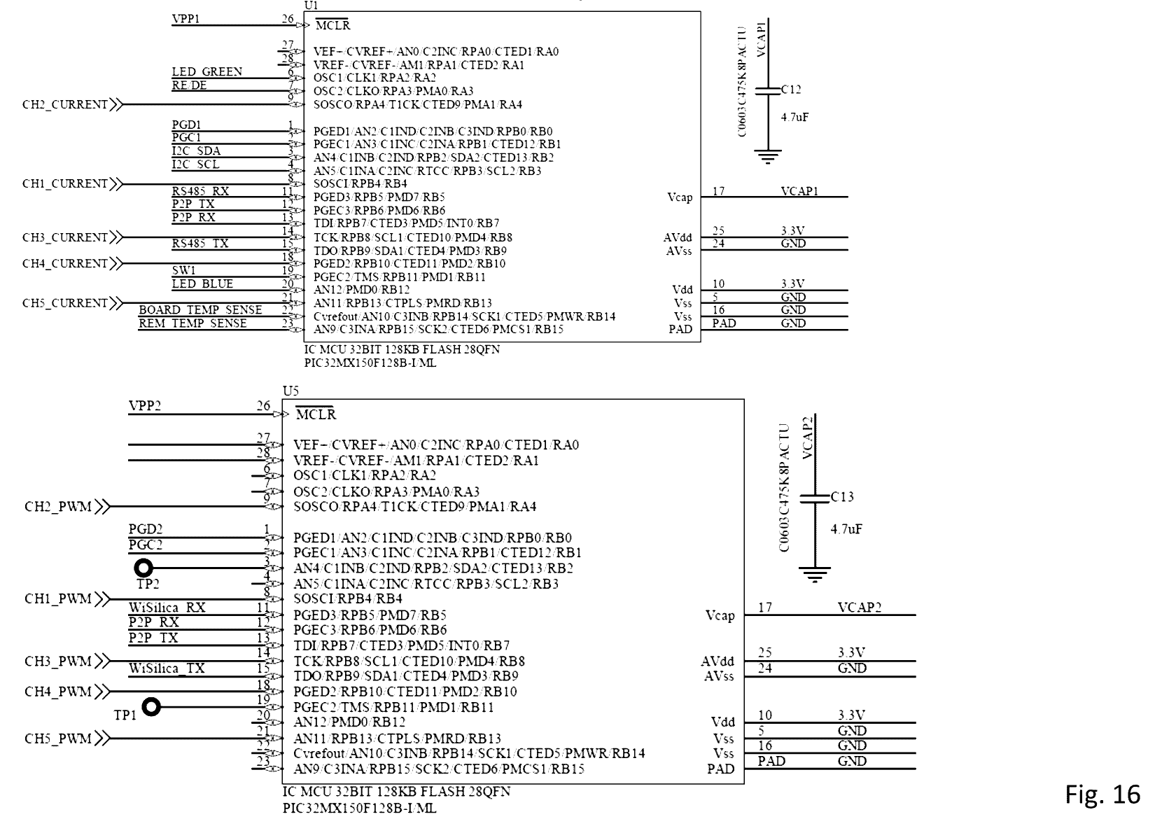

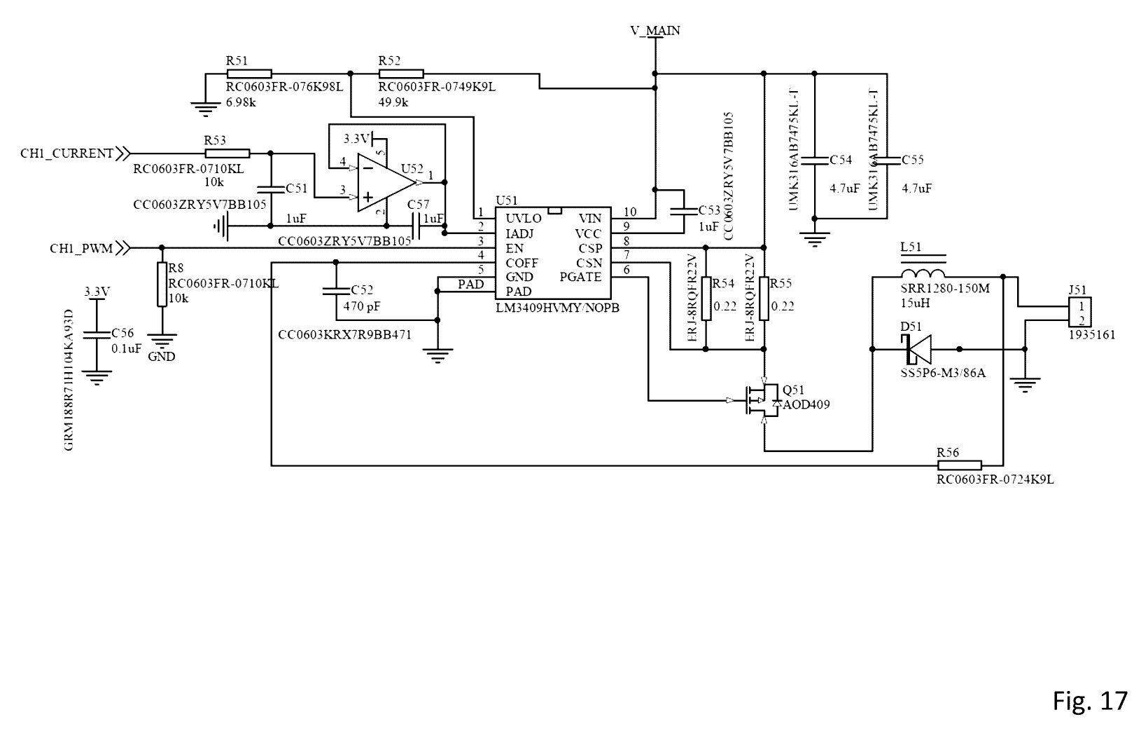

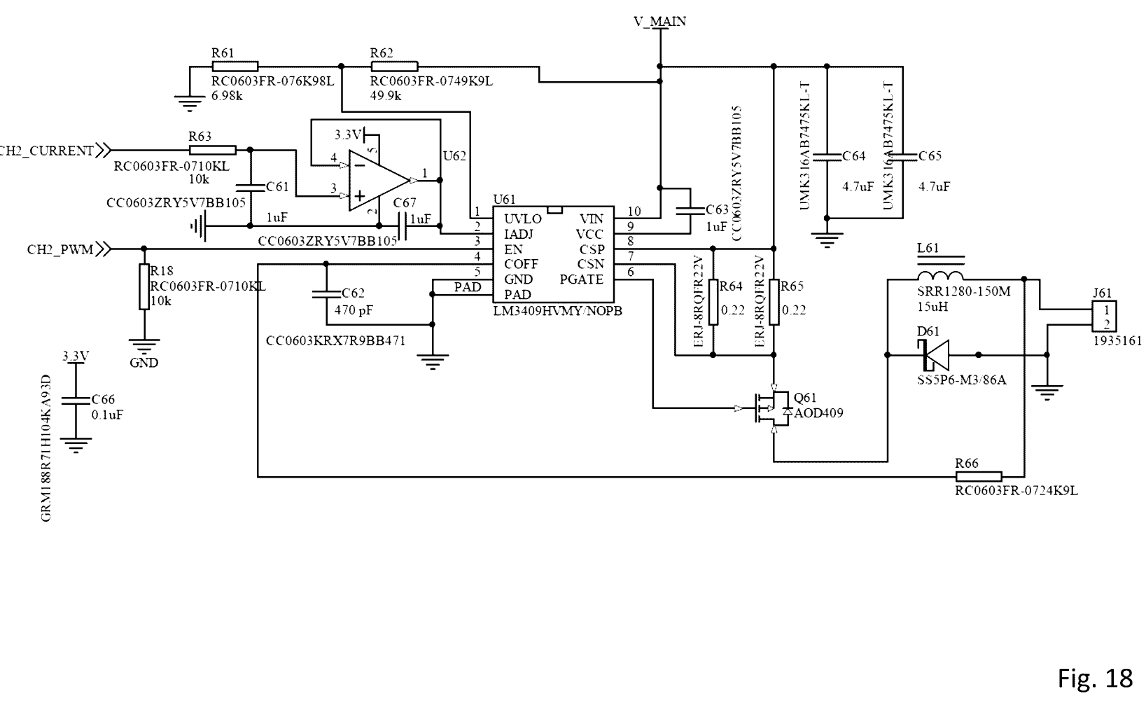

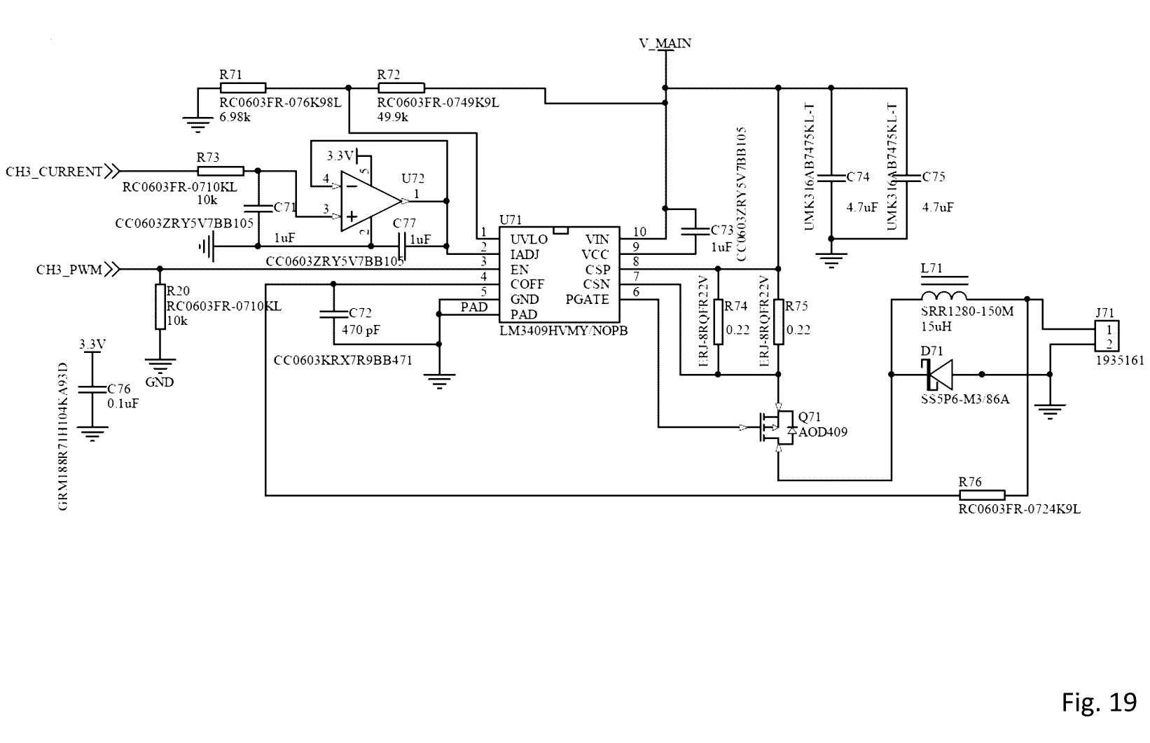

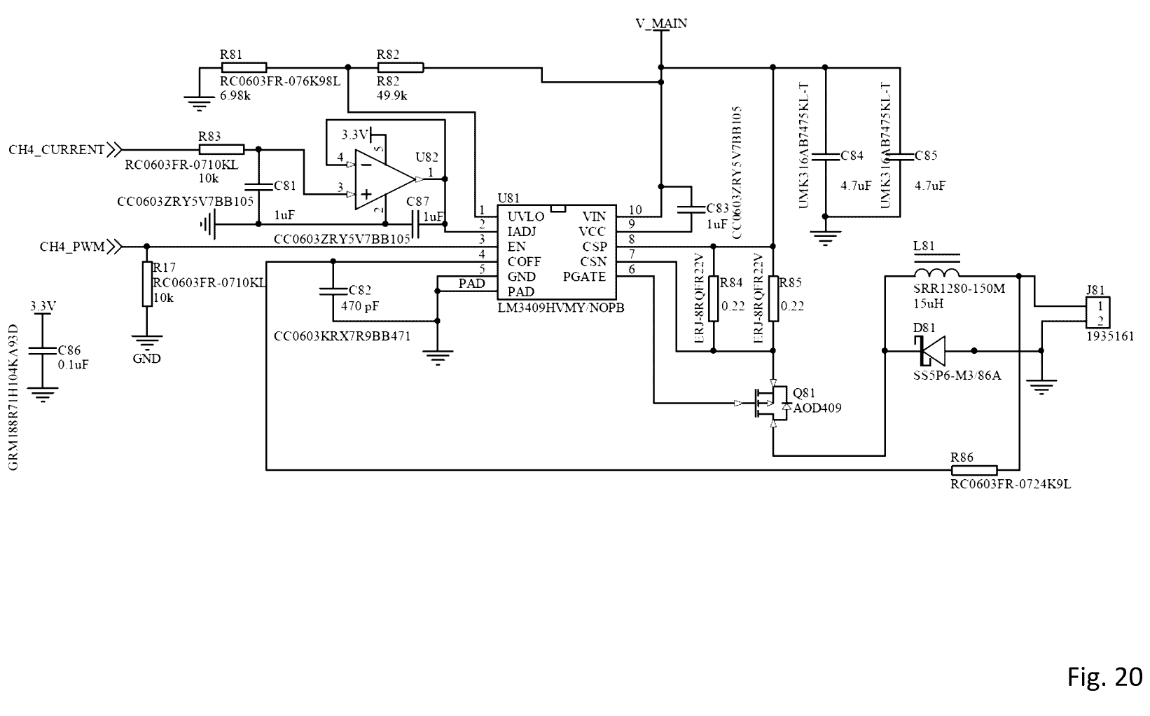

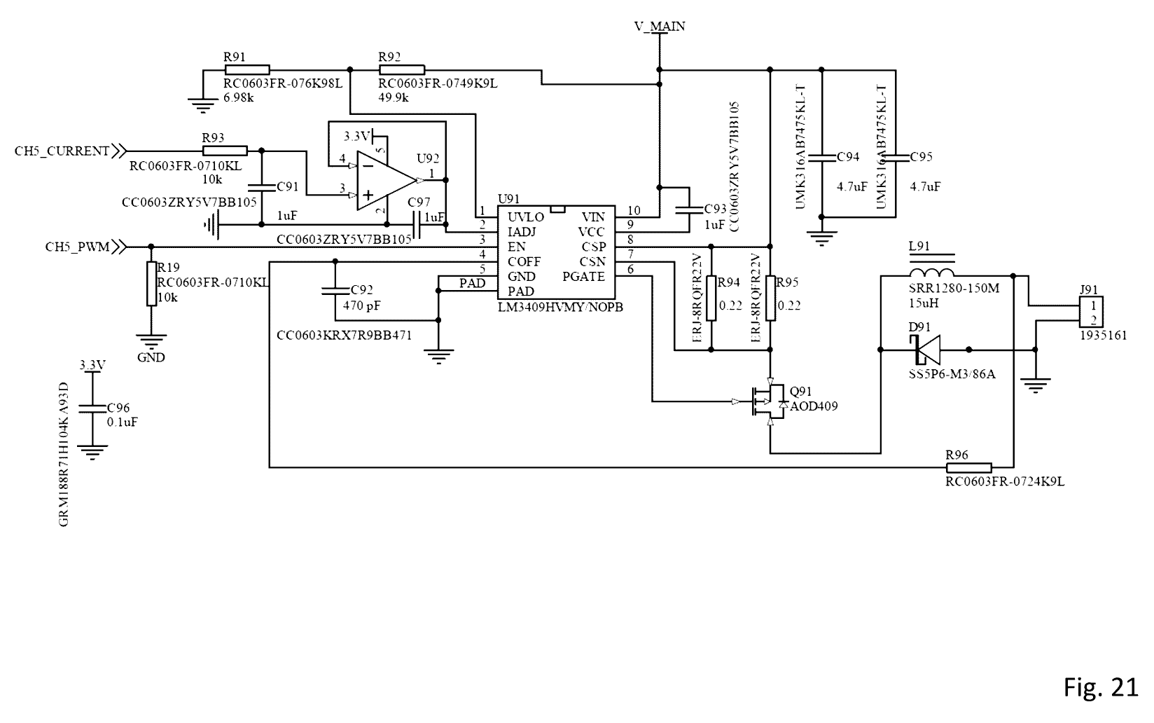

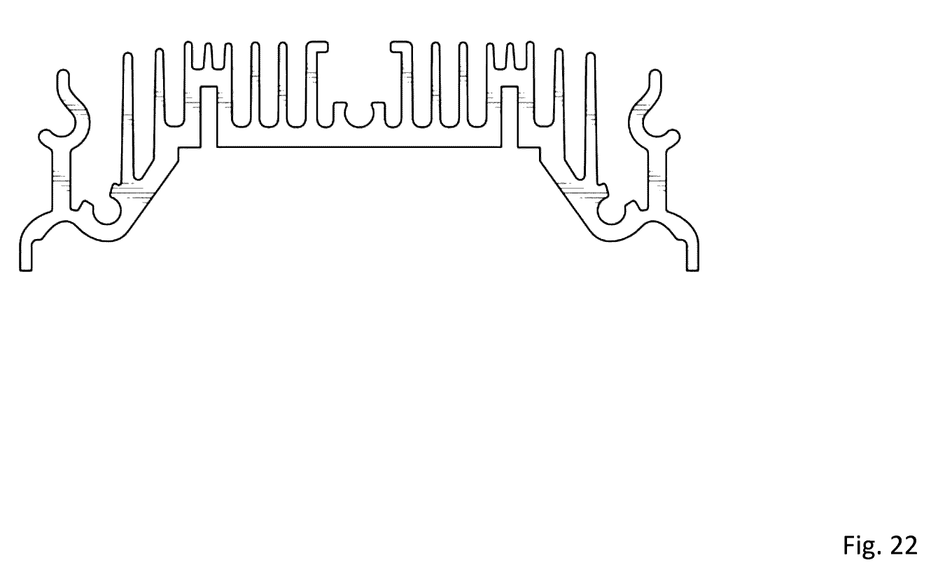

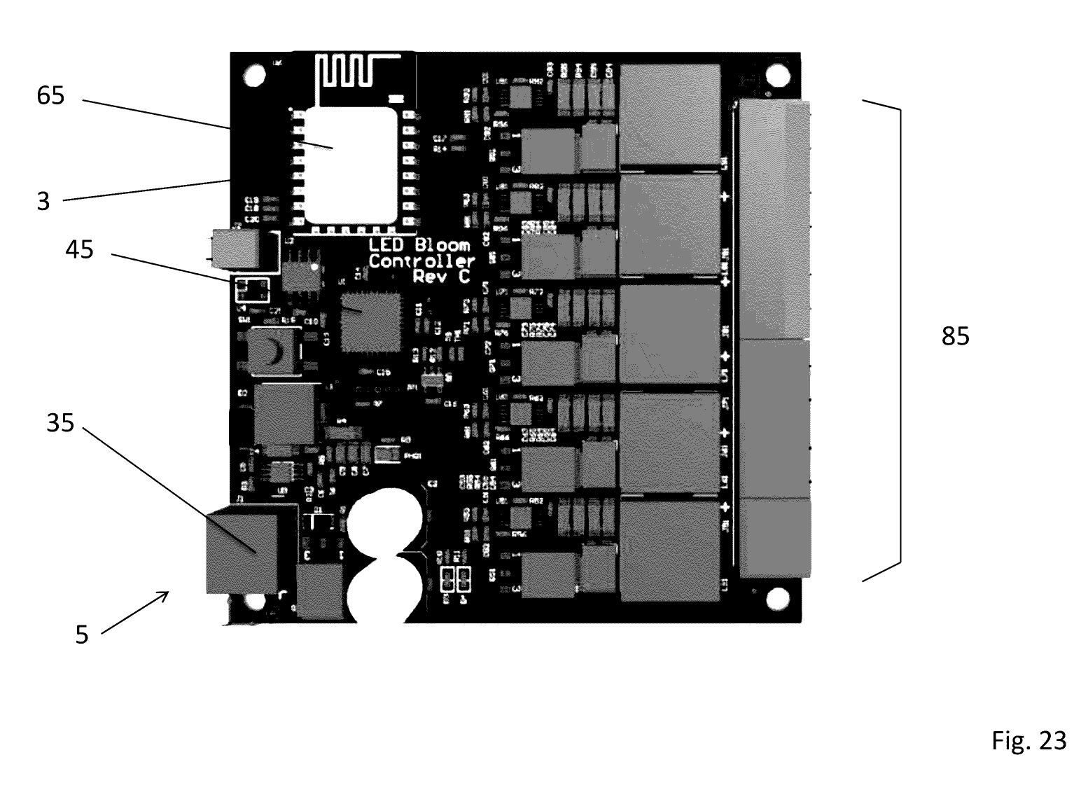

FIG. 16 shows a heat sink for an embodiment of an LED light fixture for the controller, wherein the heat sink fastens to the back of the LED light fixture.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A lighting controller, comprising:
a. one or more output channels connected to the lighting, each channel comprising a lighting driver circuit, and having independently controllable intensity of the lighting from off to full power;
b. a microcontroller containing instructions to control the intensity of the lighting by direct current or pulse width modulation;
c. a communication connection adapted to communicate wirelessly with a control program, in communication with the microprocessor; and
d. a power connection connected to the output channels, the microcontroller and the communication connection, wherein the power connection is adapted to receive power from a power source.

2. The lighting controller of claim 1 further comprising one or more sensors connected to the microcontroller selected from the group consisting of up to 400 user defined sensors.

3. The lighting controller of claim 1, further comprising a CHx buffer and a CHx driver adapted to translate instructions to and from the buffer.

4. The lighting controller of claim 1, wherein the communication connection is adapted to communicate with a plurality of other communication connections within other lighting controllers, such that the controllers may daisy chain a signal to communicate over longer distances and create a mesh network of up to 2000 devices.

5. The lighting controller of claim 1 wherein the control program is adapted to provide a fixed or user defined lighting schedules.

6. The lighting controller of claim 1, further comprising an independent timer, wherein the control program and microcontroller receive a timing signal from the timer to ensure accurate scheduling under all conditions.

7. A lighting controller system, comprising:
a. a controller comprising:
i. a power connection adapted to receive power;
ii. multiple microprocessors;
iii. a communication connection in communication with the microprocessors;
iv. a memory adapted to store data for each microprocessor;
v. one or more sensors connected to the microprocessor;
vi. one or more independently controllable channels per grow light, each channel comprising a grow light driver;
b. one or more grow lights connected to each of the controllers;
c. an app or computing device connected to the communication connection, the app or computing device comprising software with:
i. an intensity control for each output channel; and
ii. a schedule to control the off and on times of each group of luminaires.

8. The lighting controller of claim 7 further comprising a cloud server wirelessly connected to the communication connection for backing up programmed data and containing light recipes for particular genus and species of plants.

9. The lighting controller of claim 7 wherein the microprocessor contains instructions for direct current manipulation or pulse width modulation to control the intensity of each output.

10. The lighting controller of claim 7 wherein up to 400 user defined sensors may be selected including an ambient light sensor, a temperature sensor, a pH sensor, a humidity sensor, a CO2 sensor, an air flow sensor, etc.

11. The lighting controller system of claim 7, further comprising an independent time synching mechanism adapted to provide a synched time to the microprocessor, the software and the communication connection.

12. A method of operating a lighting controller comprising the steps of:
a. the app connecting to the lighting controller by a communication connection, wherein the lighting controller is connected to a plurality of channels connected to lights;
b. a user adjusting an intensity control on the app, wherein the lighting controller adjusts the output of each of the channels accordingly, between off and full-power;
c. a user inputting a light schedule, wherein the on and off times of each group of luminaires is provided by the user; and
d. the lighting controller receiving signals from one or more sensors and communicating the signals to the app.

13. The method of claim 12 further comprising the steps of describing the grow environment by:
a. creating separate groups configured to group luminaires, wherein a room and a group comprises a plurality of Luminaires controlled by one or more lighting controllers;
b. assigning one or more luminaires to each group.

14. The method of claim 12 wherein the intensity control varies power of each channel either directly or by pulse width modulation.

15. The method of claim 12 wherein the intensity of each channel by varying channel current.

16. The method of claim 13 wherein the groups may comprise rooms or other criteria for linking luminaires.

17. The method of claim 12 further comprising the step of synchronizing the app, the communication link and the lighting controller time with an independent timer.
